(19) United States
(12) Patent Application Publication
(10) Pub. No.: US 2011/0200254 A1
(43) Pub. Date: Aug. 18, 2011

(54) IMAGE PROCESSING DEVICE, IMAGE PROCESSING METHOD, AND COMPUTER PROGRAM

(75) Inventors: Mitsuru TANIGUCHI, Matsumoto-shi (JP); Yuki YAMABE, Nishinomiya-shi (JP)

(73) Assignee: SEIKO EPSON CORPORATION, Tokyo (JP)

(21) Appl. No.: 13/028,005

(22) Filed: Feb. 15, 2011

(30) Foreign Application Priority Data
Feb. 16, 2010 (JP) 2010-030944

(51) Int. Cl. G06K 9/34

(52) U.S. Cl. 382/173

(57) ABSTRACT

An image processing device that processes image data corresponding to a display image composed of a pixels on an image data by image data basis, the image data corresponding to each of a partial images obtained by dividing the display image vertically and horizontally, includes:
an input unit that inputs image data;
a image processing units that perform predetermined image processing;
an image composition input unit that sequentially inputs image data corresponding to the respective partial images processed by the plurality of image processing units, in parallel along a predetermined scanning direction, thereby inputting the image data corresponding to the display image;
a storage unit that sequentially stores the sequentially input image data; and
an image composition output unit that sequentially outputs the image data sequentially stored in the storage unit, on the unit block by unit block basis in parallel in the predetermined scanning direction.

The entire disclosure of Japanese Patent Application No. 2010-030944, filed Feb. 16, 2010 is expressly incorporated by reference herein.

### BACKGROUND

1. Technical Field

The present invention relates to a technique for image processing, and more particularly, to a technique for processing image data corresponding to a display image composed of a plurality of pixels on an image data by image data basis, the image data corresponding to each of a plurality of partial images obtained by dividing the display image vertically and horizontally.

2. Related Art

In recent years, the realization of high-resolution images input to video display apparatuses such as projectors, liquid crystal televisions, or plasma televisions has been advanced. In such apparatuses, for completing image processing on numerous pixels composing a screen image in a short time, a method is sometimes employed in which image data corresponding to an input display image is divided into a plurality of partial image data to be processed in parallel. As the technique described above, JP-A-2009-111969 has been known, for example.

After performing image processing on each of the plurality of partial image data, the respective partial image data are transmitted to an image composition unit that performs a process for determining a display arrangement position in the display image. In that case, the image data corresponding to respective partial images are input in parallel to the image composition unit. In the image composition unit, after determining the display arrangement positions of the respective partial image data, the partial image data are synchronized and transferred in parallel on a partial image by partial image basis to an image output unit that displays the display image. However, the data transfer method in the related art requires, between the image composition unit and a display unit, as many wirings for transferring data as the number of partial images to be synchronized and output. It is pointed out therefore that as the number of divided display images increases, the number of required wirings increases, which makes the structure complicated.

### SUMMARY

An advantage of some aspects of the invention is to solve at least a part of the problem described above, and the invention can be embodied as the following embodiments or application examples.

### First Application Example

A first application example is directed to an image processing device that processes image data corresponding to a display image composed of a plurality of pixels on an image data by image data basis, the image data corresponding to each of a plurality of partial images obtained by dividing the display image vertically and horizontally, including: an input unit that inputs image data corresponding to the partial images; a plurality of image processing units that are disposed corresponding to the respective partial images, receive the image data corresponding to the partial images, and perform predetermined image processing; an image composition input unit that sequentially inputs image data corresponding to the respective partial images processed by the plurality of image processing units, in parallel along a predetermined scanning direction, thereby inputting the image data corresponding to the display image; a storage unit that sequentially stores the sequentially input image data corresponding to the partial images; and an image composition output unit that groups together image data respectively corresponding to a plurality of the partial images present along the predetermined scanning direction in the display image to treat the image data as one unit block, and sequentially outputs the image data sequentially stored in the storage unit, on the unit block by unit block basis in parallel in the predetermined scanning direction.

According to the image processing device, the image composition output unit groups together image data corresponding to the respective partial images input by the image composition input unit in a predetermined scanning direction to treat the image data as a unit block, and outputs the image data on the unit block by unit block basis in parallel in the scanning direction. Therefore, in terms of structure of an image processing device, compared to a case where respective partial image data are input in parallel and output in parallel on a partial image data by partial image data basis, the number of wirings for transferring data and used for outputting image data can be reduced, which enables a simple structure. Moreover, the image data that are input in the predetermined scanning direction are output on the unit block by unit block basis where the image data are grouped together in the scanning direction, in parallel in the scanning direction. Therefore, compared to the case where respective partial image data are input in parallel and output in parallel on the partial image data by partial image data basis, a storage capacity required for a storage unit can be reduced.

### Second Application Example

A second application example is directed to the image processing device according to the first application example, wherein the image composition output unit groups together image data corresponding to every predetermined number of the partial images adjacent to each other in the predetermined scanning direction in the display image to treat the image data as the unit block.

According to the image processing device, the image composition output unit can group together image data corresponding to every predetermined number of partial images adjacent to each other in the predetermined scanning direction in the display image to treat the image data as a unit block.

### Third Application Example

A third application example is directed to the image processing device according to the second application example, wherein the image composition output unit groups together image data corresponding to all the partial images adjacent in the predetermined scanning direction in the display image to treat the image data as the unit block.

According to the image processing device, the image composition output unit groups together image data corresponding to all the partial images adjacent in the predetermined scanning direction in the display image to treat the image data as a unit block. Therefore, the number of unit blocks can be minimized.

### Fourth Application Example

A fourth application example is directed to an image processing method that processes image data corresponding to a display image composed of a plurality of pixels on an image data by image data basis, the image data corresponding to each of a plurality of partial images obtained by dividing the display image vertically and horizontally, including: inputting image data corresponding to the partial images; receiving the image data corresponding to the partial images and performing predetermined image processing; sequentially inputting image data corresponding to the respective partial images and on which the predetermined image processing is performed, in parallel along a predetermined scanning direction, thereby inputting the image data corresponding to the display image; sequentially storing the sequentially input image data corresponding to the partial images; and grouping together image data respectively corresponding to a plurality of the partial images present along the predetermined scanning direction in the display image to treat the image data as one unit block, and sequentially outputting the sequentially stored image data, on the unit block by unit block basis in parallel in the predetermined scanning direction.

According to the image processing method, in the sequentially outputting of the image data, the image data corresponding to the respective input partial images are grouped together in a predetermined scanning direction to be treated as a unit block, and are output on the unit block by unit block basis in parallel in the scanning direction. Therefore, compared to a case where respective partial image data are input in parallel and output in parallel on a partial image data by partial image data basis, the number of transfer routes for transferring data, which are required for outputting image data, can be reduced.

### Fifth Application Example

A fifth application example is directed to a computer program for processing image data corresponding to a display image composed of a plurality of pixels on an image data by image data basis, the image data corresponding to each of a plurality of partial images obtained by dividing the display image vertically and horizontally, the computer program causing a computer to realize: a function of inputting image data corresponding to the partial images; a function of receiving the image data corresponding to the partial images and performing predetermined image processing; a function of sequentially inputting image data corresponding to the respective partial images and on which the predetermined image processing is performed, in parallel along a predetermined scanning direction, thereby inputting the image data corresponding to the display image; a function of sequentially storing the sequentially input image data corresponding to the partial images; a function of grouping together image data respectively corresponding to a plurality of the partial images present along the predetermined scanning direction in the display image to treat the image data as one unit block, and sequentially outputting the sequentially stored image data, on the unit block by unit block basis in parallel in the predetermined scanning direction.

According to the computer program, a computer is caused to realize a function of grouping together image data corresponding to respective partial images that are input in a predetermined scanning direction, in the input predetermined scanning direction to treat the image data as a unit block, and outputting the image data on the unit block by unit block basis in parallel in the scanning direction. Accordingly, compared to a case where respective partial image data are input in parallel and output in parallel on a partial image data by partial image data basis, the number of transfer routes for transferring data, which are required for outputting image data, can be reduced.

### Sixth Application Example

A sixth application example is directed to an image display apparatus that inputs image data corresponding to a display image and displays an image corresponding to the image data, including: the image processing device according to any of the first to third application examples; and an image display unit that displays the display image based on the image data processed by the image processing device.

The image display apparatus includes the image processing device according to any of the first to third application examples, and therefore, the number of wirings for transferring data, which are required for the image processing device, can be reduced.

### BRIEF DESCRIPTION OF THE DRAWINGS

The invention will be described with reference to the accompanying drawings, wherein like numbers reference like elements.

FIG. 1 is a configuration diagram showing the configuration of an image processing device as an embodiment.

FIG. 2 is a block diagram showing the internal configuration of a fifth image processing unit.

FIG. 3 is a block diagram schematically showing processing in the fifth image processing unit.

FIG. 4 is an explanatory diagram schematically showing the flow of image processing in the image processing device.

FIG. 5 is an explanatory diagram illustrating peripheral pixel data necessary for performing a filtering process on partial image data.

FIG. 6 is an explanatory diagram illustrating the internal configuration of an image composition unit.

FIGS. 7A and 7B are block diagrams schematically showing the functional configuration and processing of the image composition unit.

FIG. 8 is an explanatory diagram illustrating one form of a unit block in a first modified example.

FIG. 9 is an explanatory diagram illustrating another form of a unit block in the first modified example.

FIG. 10 is an explanatory diagram illustrating still another form of a unit block in the first modified example.

FIG. 11 is an explanatory diagram illustrating a unit block in a second modified example.

### DESCRIPTION OF EXEMPLARY EMBODIMENTS

An embodiment of the invention will be described.

### A. Embodiment

### A1. Configuration of Image Processing Device

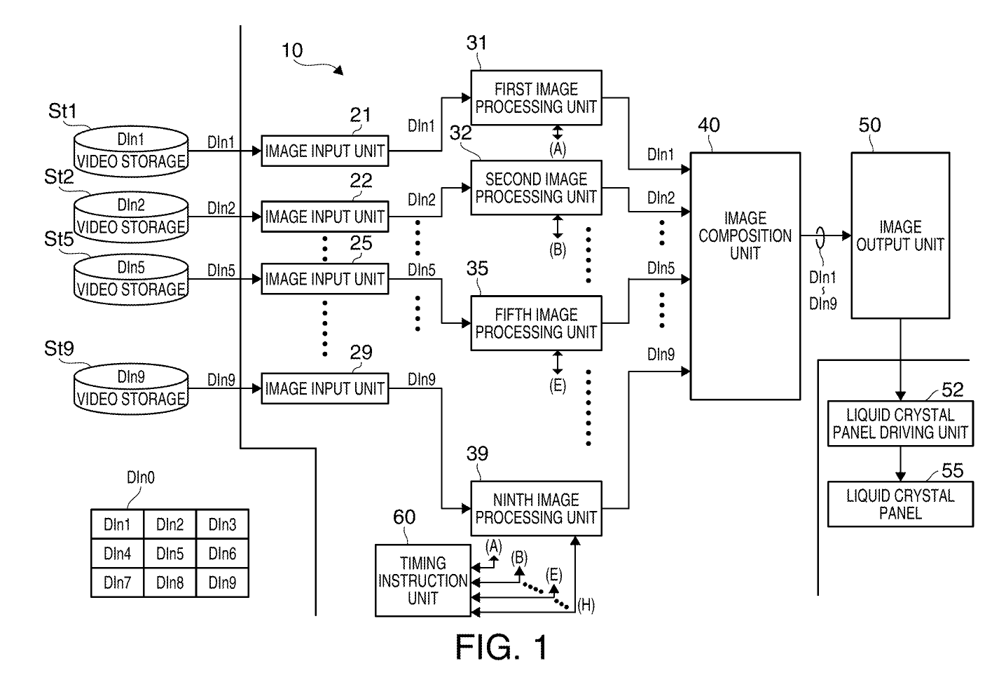

In the embodiment, description will be made in conjunction with an image processing device mounted on a high-resolution liquid crystal projector. FIG. 1 is a configuration diagram showing the configuration of an image processing device 10, as the embodiment of the invention, mounted on a liquid crystal projector. The liquid crystal projector is externally connected with video storages St1 to St9 and inputs image data via image input units 21 to 29 provided in the image processing device 10. As shown in FIG. 1, the video storages St1 to St9 respectively store partial image data DIn1 to DIn9 corresponding to partial images obtained by dividing a display image data DIn0 that is image data corresponding to one screen image into 3×3 pieces (9 pieces in total). The partial image data DIn1 to DIn9 are input from the respective video storages St1 to St9 to the image input units 21 to 29 provided in the image processing device 10. The partial image data DIn1 to DIn9 are input, as digital data, from the respective video storages St1 to St9 to the image processing device 10. In the embodiment, each of the video storages St1 to St9 is provided in a computer in a PC cluster including a plurality of computers.

The image processing device 10 includes the image input units 21 to 29, first to ninth image processing units 31 to 39, an image composition unit 40, an image output unit 50, and a timing instruction unit 60. The first to ninth image processing units 31 to 39 are nine image processing units that process in parallel the partial image data DIn1 to DIn9, respectively. The image composition unit 40 performs a process for reconstructing a display image on the partial image data DIn1 to DIn9 processed in parallel in the respective image processing units. The image output unit 50 outputs, as output signals, the partial image data processed in the image composition unit 40 to a liquid crystal panel driving unit 52 of the liquid crystal projector. The liquid crystal panel driving unit 52 displays an image on a liquid crystal panel 55 based on image data as the output signals input from the image composition unit 40. As shown in the drawing, the liquid crystal panel driving unit 52 and the liquid crystal panel 55 are configured separately from the image processing device 10. The liquid crystal panel driving unit 52 and the liquid crystal panel 55 correspond to the image display unit set forth in the claims, and the liquid crystal projector corresponds to the image display apparatus set forth in the claims.

In the image processing units 31 to 39, processing is performed in such a way that the first image processing unit 31 processes DIn1; the second image processing unit 32 processes DIn2; and so on. That is, the image processing unit numbers correspond to the partial image data numbers, so that the image processing units process the partial image data DIn1 to DIn9, respectively. In the embodiment, each of the image processing units 31 to 39 includes a digital signal processor (DSP) dedicated for image processing.

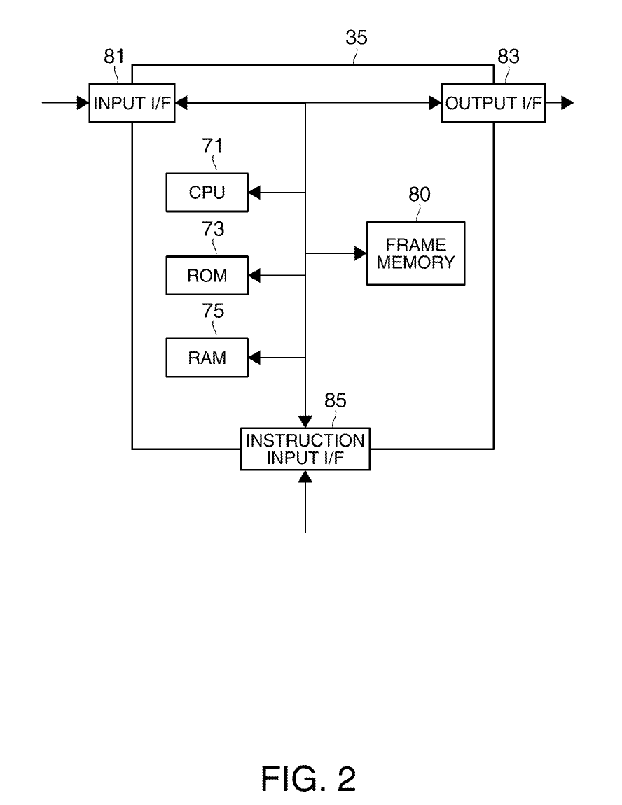

FIG. 2 is a block diagram showing the internal configuration of the fifth image processing unit 35 as a specific example. The fifth image processing unit 35 includes a CPU 71 having a function as a digital signal processor (DSP); a ROM 73 that stores an operation program and the like; a RAM 75 used as a work area; a frame memory 80 having a storage capacity slightly larger than that for image data obtained by dividing the display image data DIn0, i.e., the partial image data DIn5; an input interface 81 that receives the partial image data DIn5 from the video storage St5; an output interface 83 that outputs the partial image data DIn5 to the image composition unit 40; and an instruction input interface 85 that receives timing signals from the timing instruction unit 60. The CPU 71, which controls the entire operation of the fifth image processing unit 35, is a dedicated processor that can especially provide fast access to the frame memory 80 to perform predetermined image processing (filtering process). The function of the CPU 71 may be realized by using a field programmable gate array (FPGA), an image processing-dedicated LSI, or the like.

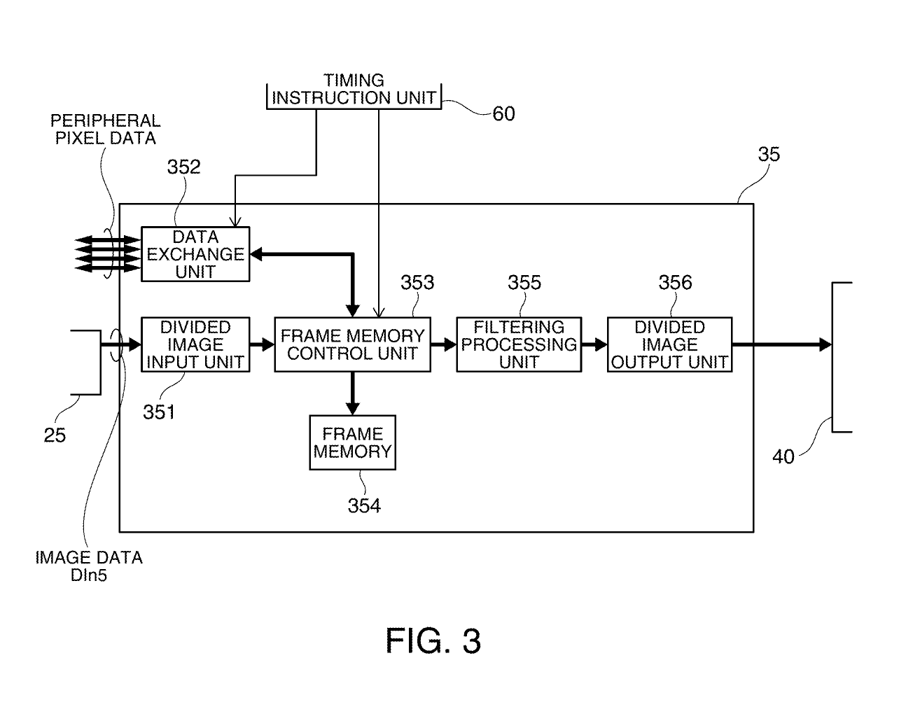

Next, the functional configuration of each of the image processing units will be described. FIG. 3 is a block diagram schematically showing processing in the fifth image processing unit 35. The fifth image processing unit 35 functionally includes a divided image input unit 351, a data exchange unit 352, a frame memory control unit 353, a frame memory 354, a filtering processing unit 355, and a divided image output unit 356. The operation of each of the blocks is actually realized by executing a predetermined program by the CPU 71. These functional blocks will be described in detail later.

### A2. Image Processing

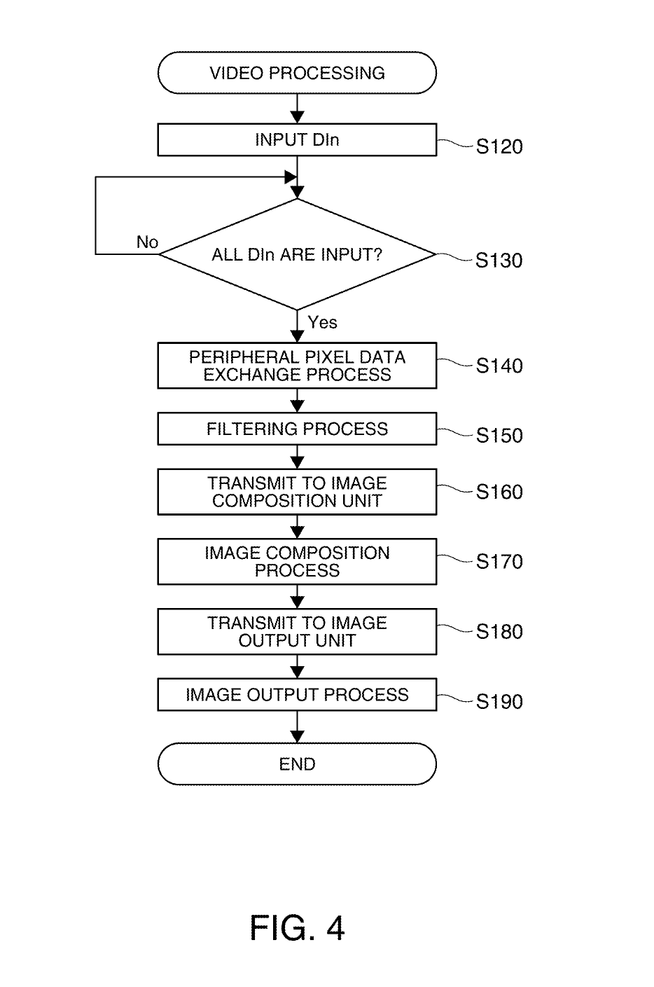

Next, image processing performed by the image processing device 10 will be described. FIG. 4 is an explanatory diagram schematically showing the flow of the image processing in the image processing device 10. The image processing starts when the partial image data DIn1 to DIn9 are input from the video storages St1 to St9 (refer to FIG. 1) to the image input units 21 to 29.

The partial image data DIn1 to DIn9 are input from the image input units 21 to 29 to the image processing units 31 to 39 via the divided image input unit 351 to 391 (refer to FIG. 3), respectively (Step S120). The frame memory control unit of each of the image processing units stores input partial image data DIn in the frame memory. When the storing of the partial image data DIn to the frame memory is completed, the frame memory control unit notifies the timing instruction unit 60 of the fact. The timing instruction unit 60 analyzes the accumulation status of the partial image data DIn in each of the image processing units 31 to 39. If it is determined that input of all the partial image data DIn1 to DIn9 to the respective image processing units is completed (Step S130: Yes), the timing instruction unit 60 instructs the data exchange unit of each of the image processing units to start data exchange. When receiving the instruction of starting data exchange from the timing instruction unit 60, each of the data exchange units performs a peripheral pixel data exchange process in which the data exchange unit exchanges peripheral pixel data necessary for processing partial image data that the image processing unit takes charges of processing, with a data exchange unit in a predetermined image processing unit (Step S140). The peripheral pixel data exchange process will be described in detail later. In view of the fact that reception of image data is sequentially performed, data exchange may be sequentially instructed to start from data exchange between image processing units which can exchange data. In the embodiment as shown in Step S130, however, it is assumed for easy understanding of the invention that data exchange is performed after all the first to ninth image processing units 31 to 39 receive image data.

When the data exchange unit of each of the image processing units completes the exchange of peripheral pixel data, each of the frame memory control units outputs the partial image data DIn stored in the frame memory and the peripheral pixel data acquired through the peripheral pixel data exchange process to the filtering processing unit. The filtering processing unit uses the two data to perform a filtering process (Step S150). After completing the filtering process, each of the filtering processing units outputs the processed data to the image composition unit 40 via the divided image output unit. In this case, the divided image output units 316 to 396 of the respective image processing units 31 to 39 output in parallel the partial image data DIn1 to DIn9 after image processing to the image composition unit 40 (Step S160).

The image composition unit 40 performs an image composition process on the partial image data DIn1 to DIn9 received in parallel from the respective divided image output units. The image composition process includes an arrangement determination process in which the arrangement of the partial image data is rearranged and the arrangement of the partial image data is adjusted so that the partial image data DIn1 to DIn9 are displayed as the display image data DIn0 when they are displayed in synchronization with one another (Step S170). After performing the image composition process, the image composition unit 40 transmits the partial image data to the image output unit 50 by a predetermined output method (Step S180). The processing performed by the image composition unit 40 will be described in detail later. The image output unit 50 receives the rearranged partial image data DIn1 to DIn9 from the image composition unit 40 and outputs, as output signals, the image data in synchronization with one another to the liquid crystal panel driving unit of the liquid crystal projector (Step S190). By repetitively performing such image processing on the input partial image data DIn1 to DIn9, the image processing device 10 performs image processing.

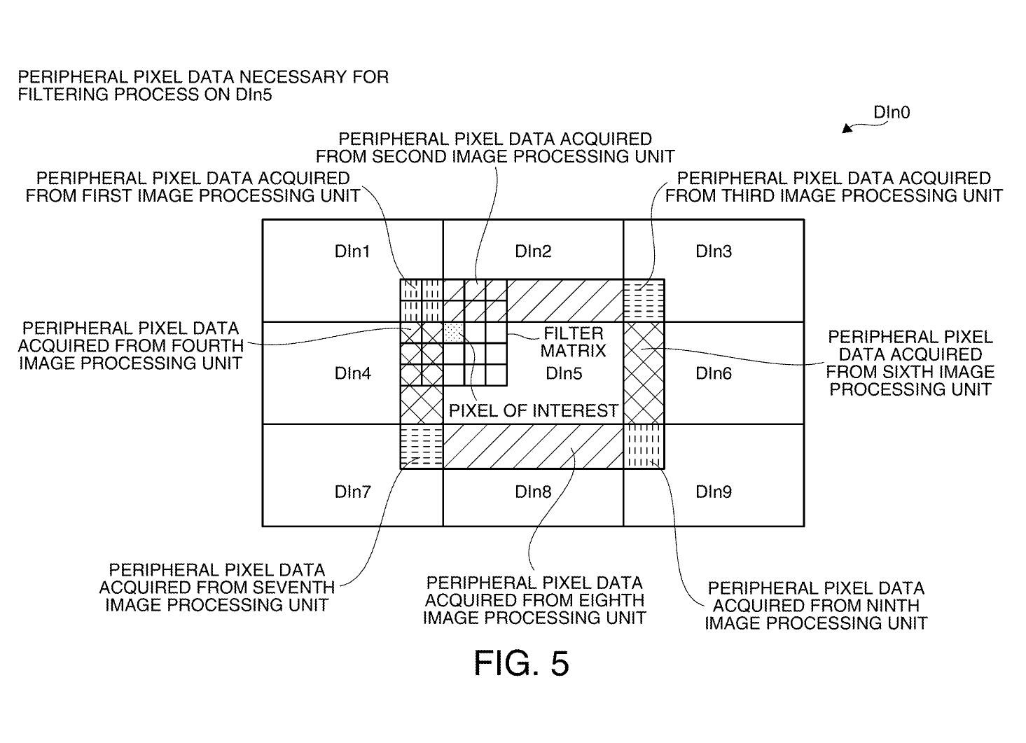

Next, the peripheral pixel data exchange process (refer to FIG. 4: Step S140) described above will be described. First, peripheral pixel data will be described. FIG. 5 is an explanatory diagram illustrating, as a specific example, peripheral pixel data necessary for the fifth image processing unit 35 to perform the filtering process on the partial image data DIn5. The filtering processing unit 355 uses a filter matrix of 5 rows×5 columns, with a pixel as an object to be processed (hereinafter also referred to as a pixel of interest) in the partial image data DIn5 as the center, to perform the filtering process on the pixel of interest with reference to pixel data of every two pixels around the pixel of interest. Specifically, the filtering process is performed with a Laplacian filter or median filter for edge enhancement or noise reduction and other image processing filters such as a Kalman filter. In the case of performing such a filtering process, when each pixel of every two pixels inside the upper and lower edges in the vertical direction and the left and right edges in the horizontal direction, i.e., four edges in total (the upper, lower, left, and right edges) of the partial image data DIn5 is an object to be processed as a pixel of interest, pixels to be referred to for the filtering process range to pixels included in the partial image data DIn1 to DIn4 and DIn6 to DIn9 that are partial image data around the partial image data DIn5. Accordingly, the fifth image processing unit 35 needs to acquire peripheral pixel data shown in FIG. 5 as peripheral pixel data from the partial image data DIn1 to DIn4 and DIn6 to DIn9 around the partial image data DIn5. The data exchange unit 352 of the fifth image processing unit 35 acquires these peripheral pixel data through the peripheral pixel data exchange process (refer to FIG. 4: Step S140).

### A3. Image Composition Process

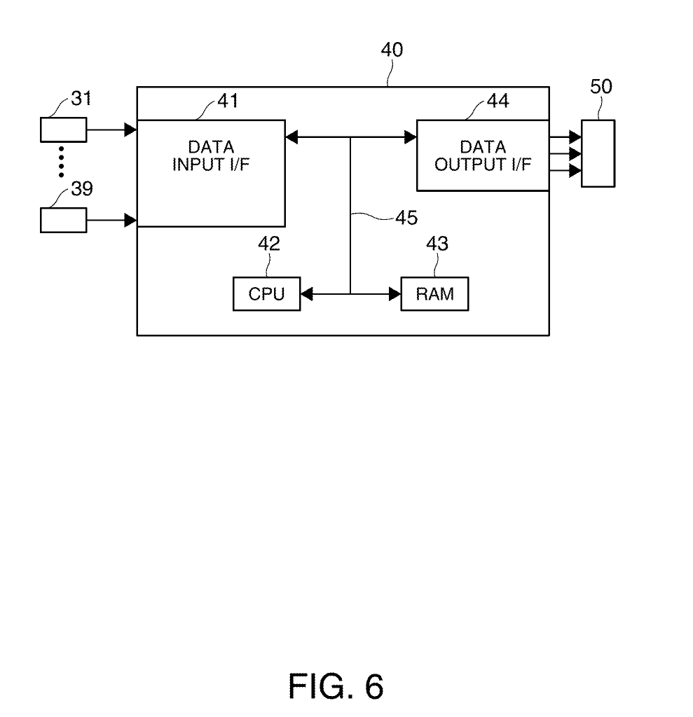

Next, processing performed by the image composition unit 40 in the embodiment will be described. First, the internal configuration of the image composition unit 40 will be described. FIG. 6 is an explanatory diagram illustrating the internal configuration of the image composition unit 40. As shown in FIG. 6, the image composition unit 40 includes a data input interface (data input IF) 41 that receives partial image data; a CPU 42 that performs arithmetic processing by the image composition unit 40; a RAM 43 used as a work area; and a data output interface (data output IF) 44 that outputs image data after performing an image composition process. The respective functional blocks are connected to one another with an internal bus 45.

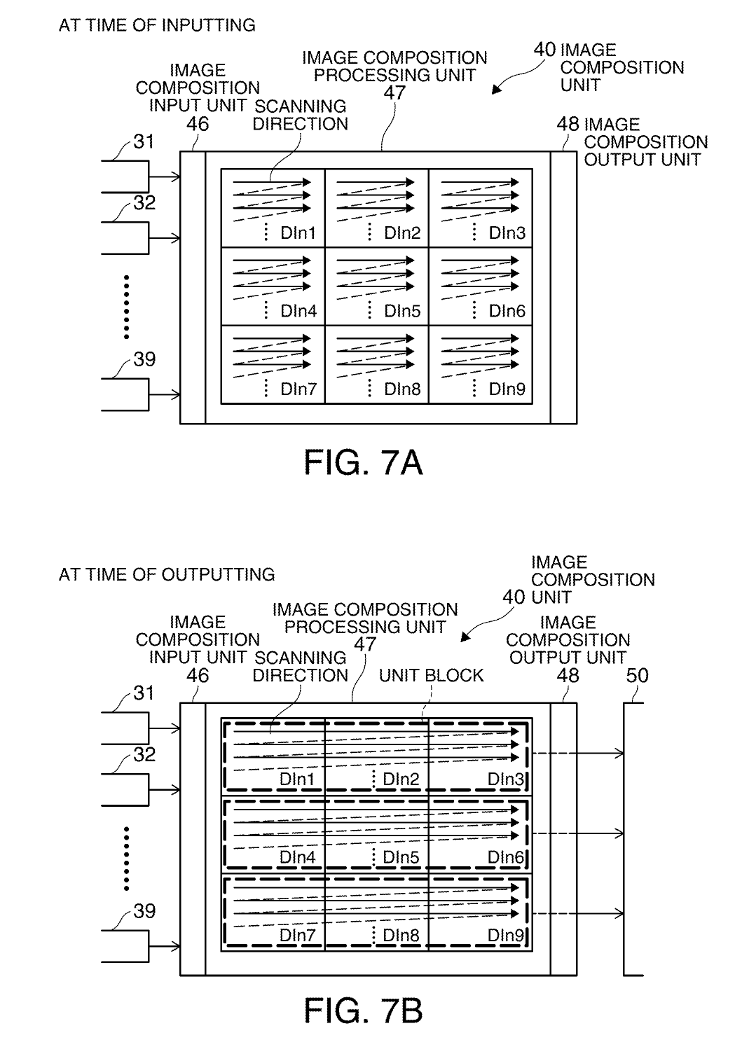

The functional configuration and processing of the image composition unit 40 will be described. FIGS. 7A and 7B are block diagrams schematically showing the functional configuration and processing of the image composition unit 40. As shown in FIG. 7A, the image composition unit 40 includes an image composition input unit 46, an image composition processing unit 47, and an image composition output unit 48. The image composition input unit 46 is a processing unit corresponding to the data input IF 41. The image composition output unit 48 is a processing unit corresponding to the data output IF 44. The image composition processing unit 47 performs an image composition process described below.

The image composition process performed by the image composition unit 40 will be described. Especially an input and output method of partial image data to and from the image composition unit 40 will be described. FIG. 7A shows how the partial image data DIn1 to DIn9 are input from the respective image processing units 31 to 39 to the image composition unit 40. As shown in FIG. 7A, the image composition unit 40 receives the partial image data DIn1 to DIn9 from the respective image processing units 31 to 39 via the image composition input unit 46. Input of the partial image data DIn1 to DIn9 from the respective image processing units 31 to 39 to the image composition unit 40 is performed by, as shown in FIG. 7A, sequentially inputting in parallel pixel data constituting the respective partial image data DIn1 to DIn9 from the respective image processing units 31 to 39 along a predetermined scanning direction (the direction of arrows in FIG. 7A). The image composition unit 40 performs the arrangement determination process in which the sequentially input pixel data are arranged next to one another so as to constitute a display image. When the arrangement is determined for each of the sequentially input pixels, pixel data whose arrangement is determined is sequentially output to the image output unit 50 via the image composition output unit 48.

Specifically, the image composition unit 40 includes, in part of the RAM 43 (refer to FIG. 6), line memories corresponding to several lines of a display image. In the embodiment, the image composition unit 40 includes line memories corresponding to two lines for DIn1 to DIn3, and similarly includes line memories corresponding to two lines for each set of DIn4 to DIn6 and DIn7 to DIn9, that is, the image composition unit includes line memories corresponding to six lines in total. The image composition unit 40 assigns, to the sequentially input pixel data, an address in the memory corresponding to an arrangement position of each of pixel data in the display image and sequentially writes the pixel data to the line memories, thereby performing the arrangement determination process. The image composition unit 40 writes and reads image data to and from the line memories for two lines, while performing bank switching. That is, the image composition unit 40 repeats a process such that the image composition unit writes input data to one of line memories, and then writes data to the other line memory while outputting the image data written to the one line memory. The image composition unit 40 assigns an address to input pixel data as well as performs image processing such as a color conversion process on the written image data. The color conversion process is performed using a lookup table (LUT) provided in the RAM 43 (FIG. 6). In the embodiment, the input and output method of data using bank switching is employed. However, it is also possible to employ a method of reading and writing data using a dual-port memory, or a method in which a line memory corresponding to one line is provided for each set of DIn1 to DIn3, DIn4 to DIn6, and DIn7 to DIn9 and writing is performed faster than reading.

Next, a process of outputting image data from the image composition unit 40 will be described. FIG. 7B is an explanatory diagram showing how the image composition unit 40 outputs the partial image data DIn1 to DIn9 written to the line memories to the image output unit 50. The image composition unit 40 outputs the sequentially input pixel data on which the arrangement determination process and the color conversion process are performed to the image output unit 50 in the following form. The image composition unit 40 groups together the partial image data DIn1 to DIn9 in the scanning direction in which respective pixel data are input, and treats the data grouped together as one unit block. As indicated by broken lines in FIG. 7B in the embodiment, the image data DIn1 to DIn9 are grouped together in the scanning direction in which the respective pixel data are input. That is, DIn1 to DIn3 are treated as one unit block, and similarly, each set of DIn4 to DIn6 and DIn7 to DIn9 is treated as one unit block. The pixel data on which the arrangement determination process is sequentially performed in the image composition unit 40 are sequentially output on the unit block by unit block basis in parallel in the same direction as the scanning direction in which the pixel data are input, to the image output unit 50 via the image composition output unit 48.

Specifically, pixel data written to the line memories as the arrangement determination process are sequentially read in the scanning direction on the unit block by unit block basis and are output to the image output unit 50 while performing bank switching. Pixel data to be next input is overwritten to a storage area of the line memory that has finished reading. Then, the arrangement determination process and the color conversion process are performed again on the overwritten image data. The image composition unit 40 repeats the input and output of the image data DIn1 to DIn9 by the above-described method to perform the image composition process.

As has been described above, in the image processing according to the image processing device 10, the image composition unit 40 outputs the image data DIn1 to DIn9 input from the respective image processing units 31 to 39, in parallel on the unit block by unit block basis. Therefore, the number of wiring systems required for transferring image data between the image processing units 31 to 39 and the image composition unit 40 is nine, which is the number of the image processing units; while the number of wiring systems for transferring data from the image composition unit 40 to the image output unit 50 can be reduced to three, which is the number of the unit blocks, making it possible to achieve simplification in terms of structure. Moreover, the image data sequentially input from the image processing units in the scanning direction are sequentially read on the unit block by unit block basis in the same direction as the scanning direction in which the data are input. Therefore, as long as the line memory that temporarily stores the input image data until the image data are output secures a storage area corresponding to at least one line for each of the unit blocks (three lines in the embodiment because there are three unit blocks), processing as the image composition unit 40 is possible. That is, compared to a case where the respective partial image data DIn1 to DIn9 are input in parallel, and the respective partial image data DIn1 to DIn9 are output in parallel after performing the arrangement determination process, it is possible in the embodiment, in which the partial image data DIn1 to DIn9 are grouped together in the scanning direction in which the image data are input to be treated as one unit block and are output in parallel in the scanning direction on the unit block by unit block basis, to reduce the number of wirings for transferring data between the image composition unit 40 and the image output unit 50 without increasing the storage capacity of the line memory.

### B. Modified Examples

The invention is not limited to the embodiment, but can be implemented in various forms within a range not departing from the gist thereof. For example, the following modifications are also possible.

### B1. First Modified Example

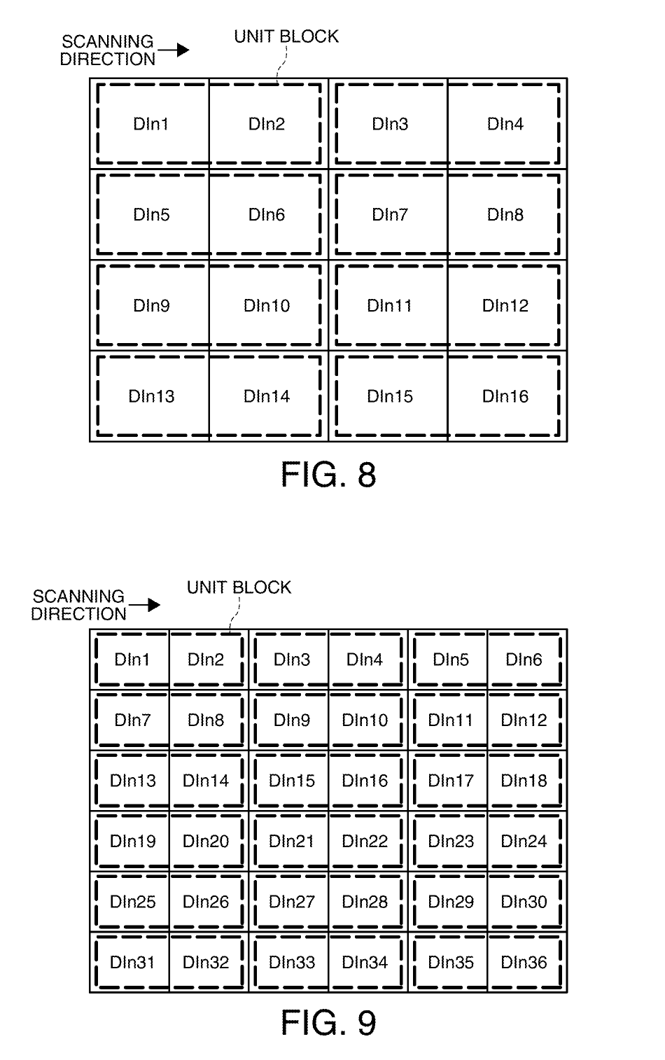

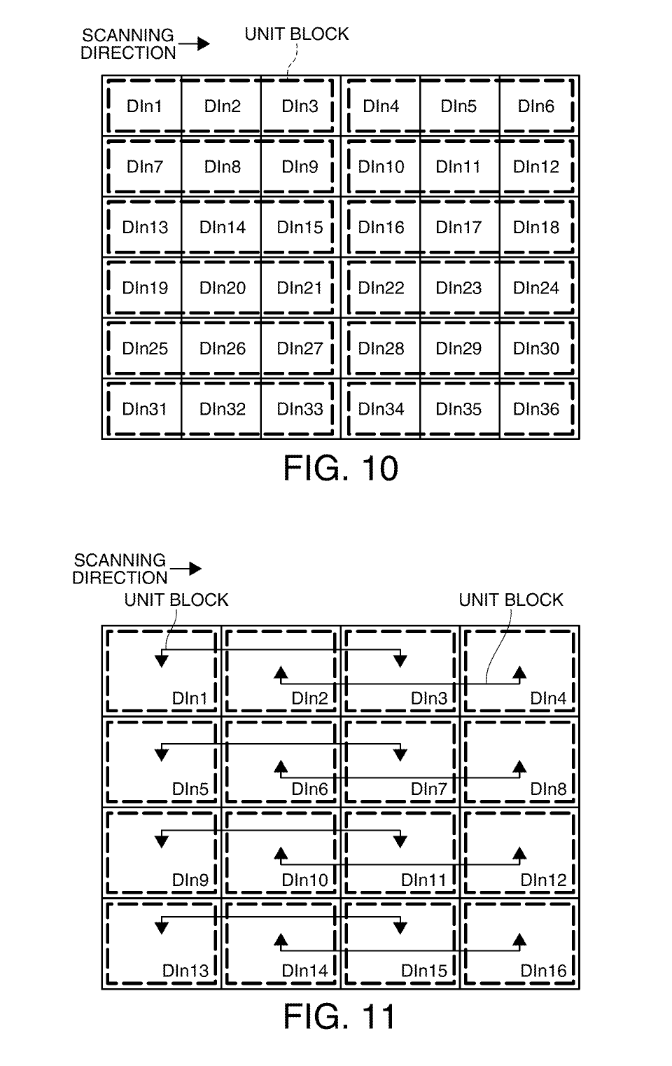

Although, in the embodiment, the display image is divided into 3×3 pieces, i.e., a total of nine pieces of partial image data for processing, this is not restrictive. It is possible to divide, for processing, image data corresponding to a display image into 6×6 pieces, 9×9 pieces, or the like, within a range of the number of image processing units that the image processing device 10 can include. Although, as shown in FIG. 7B in the embodiment, all of partial image data adjacent in the scanning direction are treated as one unit block, this is not restrictive. As shown in FIGS. 8 to 10, for example, two or three partial image data adjacent in the scanning direction, within a range of the number of divided display images in the scanning direction, can be grouped together to be treated as a unit block, to thereby perform processing similar to that of the embodiment. Even when processing is performed in this manner, an advantageous effect similar to that of the embodiment can be provided.

### B2. Second Modified Example

Although, in the embodiment and the first modified example, partial images adjacent in the scanning direction are grouped together to be treated as one unit block, this is not restrictive. Partial images not adjacent to each other may be grouped together in the scanning direction to be treated as one unit block. In other words, any plurality of partial image blocks arranged in the scanning direction in terms of arrangement relationship are treated as one unit block. FIG. 11 shows a specific example of that case. In the specific example shown in FIG. 11, every other partial images arranged in the scanning direction are treated as one unit block. Partial images connected with a double-headed arrow shown in FIG. 11 are treated as one unit block. As for partial image data that are input to the image composition unit 40, similarly to the embodiment, partial images are input in parallel from the respective image processing units, and upon outputting, image data are output in a scanning direction in parallel on the unit block by unit block basis as shown in FIG. 11. For example, an output method is as follows: as shown in FIG. 11, the partial image data DIn1 and DIn3 form one unit block; for outputting image data of this unit block in this case, image data in the first line of DIn1 is output, and then image data in the first line of DIn3 is output; and thereafter, image data in the second line of DIn1 is output in the scanning direction, and then, image data in the second line of DIn3 is output. In the same manner, image data to the last line of the unit block composed of DIn1 and DIn3 is output. This output for each unit block is performed in parallel on the unit block by unit block basis, whereby image data of the entire display image is output. Even with this processing, an advantages effect similar to that of the embodiment and the first modified example can be provided.

What is claimed is:

1. An image processing device that processes image data corresponding to a display image composed of a plurality of pixels on an image data by image data basis, the image data corresponding to each of a plurality of partial images obtained by dividing the display image vertically and horizontally, comprising:
an input unit that inputs image data corresponding to the partial images;
a plurality of image processing units that are disposed corresponding to the respective partial images, receive the image data corresponding to the partial images, and perform predetermined image processing;
an image composition input unit that sequentially inputs image data corresponding to the respective partial images processed by the plurality of image processing units, in parallel along a predetermined scanning direction, thereby inputting the image data corresponding to the display image;
a storage unit that sequentially stores the sequentially input image data corresponding to the partial images; and
an image composition output unit that groups together image data respectively corresponding to a plurality of the partial images present along the predetermined scanning direction in the display image to treat the image data as one unit block, and sequentially outputs the image data sequentially stored in the storage unit, on the unit block by unit block basis in parallel in the predetermined scanning direction.

2. The image processing device according to claim 1, wherein
the image composition output unit groups together image data corresponding to every predetermined number of the partial images adjacent to each other in the predetermined scanning direction in the display image to treat the image data as one unit block.

3. The image processing device according to claim 2, wherein
the image composition output unit groups together image data corresponding to all the partial images adjacent in the predetermined scanning direction in the display image to treat the image data as one unit block.

4. An image processing method that processes image data corresponding to a display image composed of a plurality of pixels on an image data by image data basis, the image data corresponding to each of a plurality of partial images obtained by dividing the display image vertically and horizontally, comprising:
inputting image data corresponding to the partial images;
receiving the image data corresponding to the partial images and performing predetermined image processing;
sequentially inputting image data corresponding to the respective partial images and on which the predetermined image processing is performed, in parallel along a predetermined scanning direction, thereby inputting the image data corresponding to the display image;
sequentially storing the sequentially input image data corresponding to the partial images; and
grouping together image data respectively corresponding to a plurality of the partial images present along the predetermined scanning direction in the display image to treat the image data as one unit block, and sequentially outputting the sequentially stored image data, on the unit block by unit block basis in parallel in the predetermined scanning direction.

5. A computer program for processing image data corresponding to a display image composed of a plurality of pixels on an image data by image data basis, the image data corresponding to each of a plurality of partial images obtained by dividing the display image vertically and horizontally, the computer program causing a computer to realize:
a function of inputting image data corresponding to the partial images;
a function of receiving the image data corresponding to the partial images and performing predetermined image processing;
a function of sequentially inputting image data corresponding to the respective partial images and on which the predetermined image processing is performed, in parallel along a predetermined scanning direction, thereby inputting the image data corresponding to the display image;
a function of sequentially storing the sequentially input image data corresponding to the partial images;
a function of grouping together image data respectively corresponding to a plurality of the partial images present along the predetermined scanning direction in the display image to treat the image data as one unit block, and sequentially outputting the sequentially stored image data, on the unit block by unit block basis in parallel in the predetermined scanning direction.

6. An image display apparatus that inputs image data corresponding to a display image and displays an image corresponding to the image data, comprising:
the image processing device according to claim 1; and
an image display unit that displays the display image based on the image data processed by the image processing device.

7. An image display apparatus that inputs image data corresponding to a display image and displays an image corresponding to the image data, comprising:
the image processing device according to claim 2; and
an image display unit that displays the display image based on the image data processed by the image processing device.

8. An image display apparatus that inputs image data corresponding to a display image and displays an image corresponding to the image data, comprising:
the image processing device according to claim 3; and
an image display unit that displays the display image based on the image data processed by the image processing device.
